(19) United States
(12) Patent Application Publication
(10) Pub. No.: US 2025/0316725 A1
(43) Pub. Date: Oct. 9, 2025

(54) Fuel Cell Air Recirculation System and Control Method

(71) Applicant: Infintium Fuel Cell Systems, Inc., Greenville, SC (US)

(72) Inventor: Chad Anthony Lemon, Simpsonville, SC (US)

(21) Appl. No.: 19/030,809

(22) Filed: Jan. 17, 2025

Related U.S. Application Data
(60) Provisional application No. 63/631,877, filed on Apr. 9, 2024.
(60) Provisional application No. 63/634,513, filed on Apr. 16, 2024.

(51) Int. Cl. H01M 8/04014; H01M 8/04007; H01M 8/0432; H01M 8/04701; H01M 8/04746

(52) U.S. Cl. CPC H01M 8/04014; H01M 8/04037; H01M 8/04074; H01M 8/0435; H01M 8/04365; H01M 8/04708; H01M 8/04761

(57) ABSTRACT

A system includes a first fan configured to dissipate excess heat generated during electrochemical reactions that occur within a fuel cell stack of a fuel cell system and to direct exhaust air of the fuel cell system. A first air shroud surrounds the first fan, and the first air shroud includes a hinged door. The hinged door is configured to divert exhaust air from the first fan to an inlet of the fuel cell stack to keep an inlet air temperature of the fuel cell stack above a predetermined temperature level.

### CROSS-REFERENCE TO RELATED APPLICATIONS

This patent application claims priority to U.S. Provisional Application No. 63/631,877, filed on Apr. 9, 2024, entitled “Fuel Cell Air Recirculation System and Control Method,” and U.S. Provisional Application No. 63/634,513, filed on Apr. 16, 2024, also entitled “Fuel Cell Air Recirculation System and Control Method,” which are both incorporated herein by reference as if reproduced in their entirety.

### TECHNICAL FIELD

The present disclosure relates to the field of fuel cell systems, and, in particular embodiments, to a fuel cell air recirculation system and control method thereof.

### BACKGROUND

Currently, lead-acid batteries are utilized to power electric forklifts. In contrast to internal combustion engines, forklifts powered by lead-acid batteries operate quietly and offer a cleaner, more environmentally friendly alternative. However, lead-acid batteries are plagued by numerous issues in both production and use. During operation, as the capacity of the lead-acid battery diminishes, the performance of the forklift declines, resulting in reduced speed and inadequate lifting capacity, significantly impacting work efficiency. Moreover, lead-acid batteries require lengthy recharging periods after use. Additionally, the use of lead-acid batteries can lead to the generation of acid mist, a concern in certain logistic centers where the presence of detected lead is prohibited. Furthermore, the production of lead-acid batteries contributes to environmental pollution.

As technologies further advance, fuel cell systems have emerged as efficient and dependable power sources to replace lead-acid batteries in forklift applications. Compared to their lead-acid counterparts, fuel cell systems offer numerous advantages, including higher energy density, extended lifespan, rapid refueling/recharging capabilities, environmentally friendly operation, enhanced efficiency, scalability, and more.

Fuel cell systems are power supply systems designed to generate electricity through a chemical reaction between a fuel and an oxidizing agent. For instance, certain types of fuel cells utilize hydrogen as the fuel and oxygen from the air as the oxidizer, producing only water and heat as byproducts. These systems generate electricity with significantly lower emissions compared to conventional combustion-based technologies, presenting a clean, efficient, and adaptable solution for various power generation needs.

In a forklift fuel cell system, in order to seamlessly replace the existing lead-acid battery without necessitating modifications to the forklift itself, all components must be consolidated within a rectangular chamber designed for lead-acid batteries. The forklift fuel cell system includes various elements such as a controller, an energy storage device, a dc/dc power converter, a contactor, a fuel cell system, a hydrogen filling valve, a hydrogen bottle, a hydrogen system, etc. To achieve a weight equivalent to that of the lead-acid battery in order to maintain vehicle performance, additional weights must be incorporated.

Forklifts may operate in industrial freezer environments, necessitating that the inlet air temperature of the fuel cell system remains above a certain threshold. When the inlet air temperature falls below this predetermined level, a heater can be introduced into the fuel cell system to warm the incoming air. However, this current solution entails additional expenses, intricacies, and impacts performance. It is desirable to have a simple and efficient solution to address this issue. The present disclosure addresses this need.

### SUMMARY

These and other problems are generally solved or circumvented, and technical advantages are generally achieved, by preferred embodiments of the present disclosure which provide a fuel cell air recirculation system and control method thereof.

In accordance with an embodiment, a system comprises a first fan configured to dissipate excess heat generated during electrochemical reactions that occur within a fuel cell stack of a fuel cell system and to direct exhaust air of the fuel cell system; and a first air shroud surrounding the first fan, wherein the first air shroud includes a hinged door, and the hinged door is configured to divert exhaust air from the first fan to an inlet of the fuel cell stack to keep an inlet air temperature of the fuel cell stack above a predetermined temperature level.

In accordance with another embodiment, a method comprises configuring a first fan to dissipate excess heat generated during electrochemical reactions that occur within a fuel cell stack of a fuel cell system; placing a first air shroud surrounding the first fan, wherein the first air shroud includes a hinged door; and adjusting an opening angle of the hinged door, to divert exhaust air from the first fan to an inlet of the fuel cell stack to keep an inlet air temperature of the fuel cell stack above a predetermined temperature level.

Features described in the context of one embodiment may be used in combination with other embodiments. For example, each of the optional features described above in the context of the apparatus may be used in combination with the system. Each of the optional features described above in the context of the method may be used in combination with the system. Each of the optional features described above in the context of the apparatus may be used in combination with the method.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A is a diagram of an example fuel cell power supply system in a perspective view according to embodiments of the present disclosure;

FIG. 1B is an enlarged partial view of the fuel cell power supply system shown in FIG. 1A, featuring an exhaust air recirculation door in accordance with various embodiments of the present disclosure;

FIG. 2 is a schematic block diagram of the fuel cell power supply system in FIGS. 1A and 1B;

FIGS. 3 and 4 illustrate perspective views of the fuel cell power supply system, featuring an exhaust air recirculation door in accordance with various embodiments of the present disclosure;

FIG. 5 is a simplified diagram of an example fuel cell power supply system, featuring an exhaust air recirculation door in accordance with various embodiments of the present disclosure;

FIG. 6 illustrates a flow chart of an example method for controlling an exhaust air recirculation door in a fuel cell power supply system, in accordance with various embodiments of the present disclosure;

FIG. 7 is a flowchart of another example method for controlling an exhaust air recirculation door in a fuel cell power supply system, in accordance with various embodiments of the present disclosure;

FIG. 8 is a flowchart of another example method for controlling an exhaust air recirculation door in a fuel cell power supply system, in accordance with various embodiments of the present disclosure;

FIG. 9 is a flowchart of another example method for controlling an exhaust air recirculation door in a fuel cell power supply system, in accordance with various embodiments of the present disclosure;

FIG. 10 is a flowchart of an example method for controlling an exhaust air recirculation door and a heater in a fuel cell power supply system, in accordance with various embodiments of the present disclosure;

FIG. 11 is a flowchart of another example method of controlling an exhaust air recirculation door and a heater in a fuel cell power supply system, in accordance with various embodiments of the present disclosure; and

FIG. 12 illustrates a flow chart method for controlling an exhaust air recirculation door in a fuel cell power supply system, in accordance with various embodiments of the present disclosure.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood within the scope of this disclosure. It is therefore intended that the appended claims encompass any such modifications or embodiments.

In addition, terms “first”, “second”, and so on, are only used to distinguish one feature (e.g., one entity or operation) from another feature (e.g., another entity or operation), and should not be interpreted as indicating or implying a relative importance, an order, or a quantity of indicated features. A feature limited with “first” or “second” may explicitly indicate or implicitly include one or more of the features.

The present disclosure will be described with respect to preferred embodiments in a specific context, namely a fuel cell air recirculation system and its control method for forklift applications. The disclosure may also be applied, however, to a variety of electric vehicles. Hereinafter, various embodiments will be explained in detail with reference to the accompanying drawings.

The present disclosure primarily focuses on an air-cooled fuel cell system, where heat generated during electrochemical reactions is dissipated by exhaust fan(s) that circulate air to regulate the system's temperature. However, the disclosed system may also be applicable to hybrid cooling configurations that combine air cooling with liquid cooling. In such configurations, exhaust fan(s) can complement the liquid cooling system by dissipating residual heat or managing the temperature of the fuel cell system and its components.

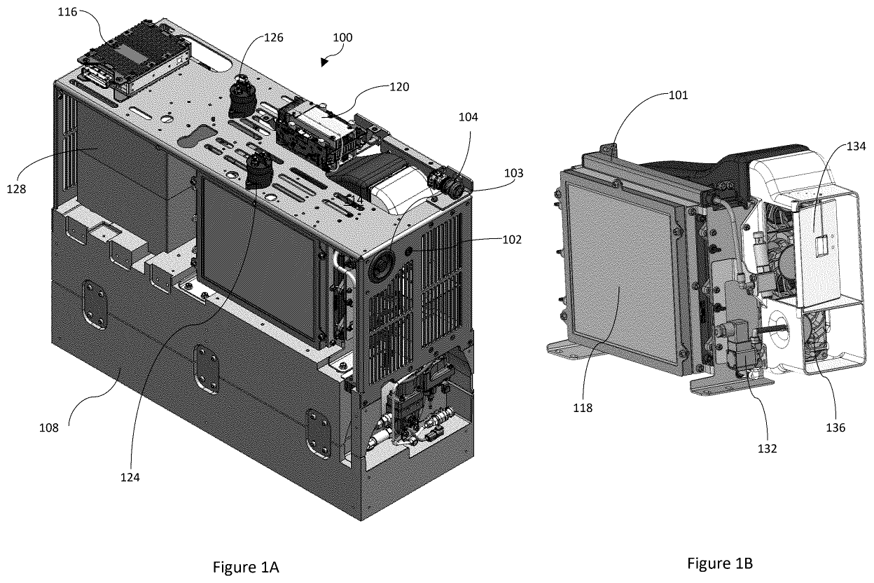

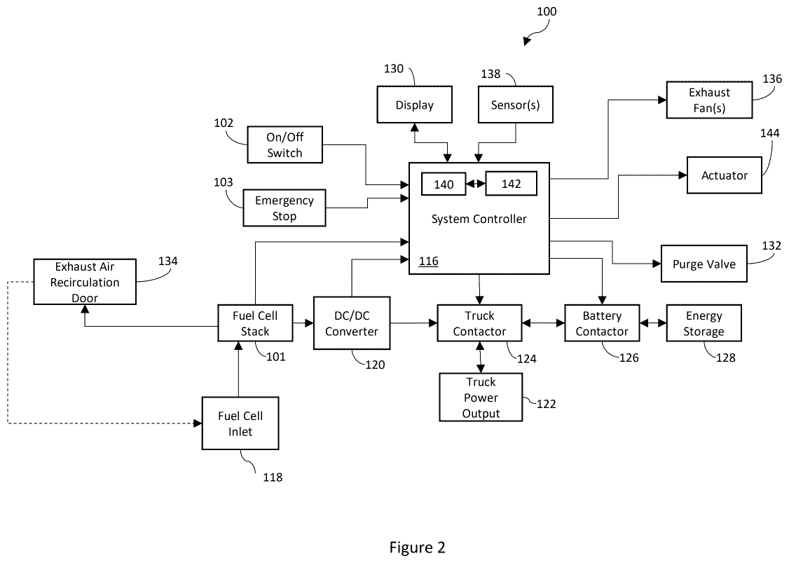

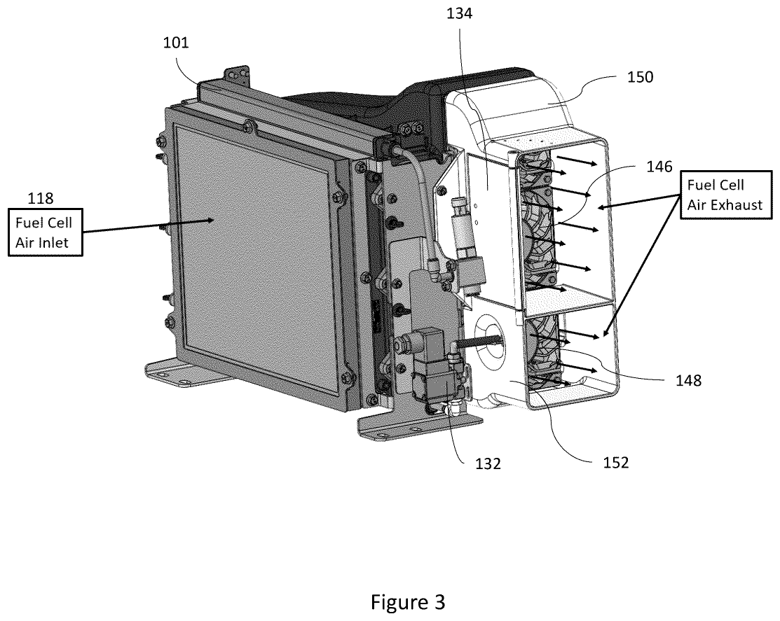

The following description is provided with reference to FIGS. 1A, 1B, and 2. FIG. 1A illustrates a perspective view of an exemplary fuel cell power supply system 100 in accordance with embodiments of the present disclosure. FIG. 1B provides an enlarged partial view of the fuel cell power supply system 100 shown in FIG. 1A, featuring an exhaust air recirculation door. FIG. 2 is a schematic block diagram of the fuel cell power supply system 100 in FIGS. 1A and 1B, which shows an example implementation of the fuel cell power supply system. The terms of “fuel cell power supply system”, “fuel cell system” and “system” are used interchangeably in the present disclosure. In this example, the fuel cell power supply system 100 uses hydrogen as the fuel. However, hydrogen is merely used as an example for illustration purpose. Any other fuel applicable for fuel cell power systems may also be used.

The fuel cell power supply system 100 as shown in FIGS. 1A and 1B may comprise a fuel cell stack 101, an on/off switch 102, an emergency stop switch 103, a fill port 104, a system base frame 108, a radiator fan 110, a system controller 116, a fuel cell air inlet 118, a power dc/dc converter 120, a truck contactor 124, a battery contactor 126, an energy storage device 128, a purge valve 132, an exhaust air recirculation door 134, and air exhaust fan(s) 136. The fuel cell system 100 may further comprise a pressure regulator 106, a fuel storage tank 107, an air compressor 115, a truck power output 122, and a display 130, which are not shown in FIGS. 1A and 1B. The terms of “air exhaust fan”, “exhaust fan”, and “fan” are used interchangeably in the present application. The terms of “fuel cell air inlet” and “fuel cell inlet” are used interchangeably in the present disclosure.

Components of the fuel cell system 100 in this example are mainly arranged on or above the system base frame 108 in a system housing (not shown). The fuel cell stack 101 may be arranged close to a rear plate of the fuel cell system 100. As an example, the fuel cell stack 101 may be mounted on the rear plate. The rear plate may be part of the system housing. The fuel cell stack 101 may include one or more fuel cells, which may be combined in series into a fuel cell stack (stacked on top of each other) as typically used. A fuel cell is an electrochemical cell that converts chemical energy of a fuel (e.g., hydrogen) and an oxidizing agent (e.g., oxygen) into electricity. The fuel cell inlet 118 is responsible for supplying air to the fuel cell stack 101, ensuring the necessary oxygen is provided for the electrochemical reactions. As well known, a fuel cell typically includes an anode, cathode, and an electrolyte membrane. In operation, hydrogen is passed through the anode, while oxygen is passed through the cathode. At the anode, a catalyst splits the hydrogen molecules into electrons and protons. The protons pass through the porous electrolyte membrane, while the electrons pass through a circuit, generating an electric current. At the cathode, the protons, electrons, and oxygen combine to produce water and heat. A typical fuel cell stack may include hundreds of fuel cells. The amount of power produced by a fuel cell may depend upon various factors, such as the fuel cell type, the fuel cell size, the temperature at which it operates, and the pressure of the gases supplied to the fuel cells, and so on.

The on/off switch 102 is used to turn on or off the fuel cell system 100. The emergency stop switch 103 is configured to stop operation of the fuel cell system 100 immediately in case of emergency, e.g., by cutting off the supply of the fuel.

The fuel (i.e., hydrogen) of the fuel cell system 100 is stored in the fuel tank 107. The fuel tank 107 may be arranged below the fuel cell stack 101. Hydrogen may be filled into the fuel tank 107 through the fill port 104. Fuel stored in the fuel tank 107 is maintained at a specific pressure level, which can be regulated using the pressure regulator 106 to ensure optimal operation of the fuel cell system. The exhaust fan(s) 136 are designed to regulate the temperature of the fuel cell system 100 by dissipating excess heat generated during electrochemical reactions within the fuel cell stack 101. The purge valve 132, as shown in FIG. 1B, may temporarily open during the purging process of the fuel cell stack 101 to discharge purge exhaust. The purge exhaust may primarily include water and non-reactive components, such as traces of unreacted hydrogen, and possible impurities entering the fuel. The purge exhaust will exit the system after exiting the purge valve 132 and being pushed from the system by the exhaust fan(s) 136.

The amount of air available for the electrochemical reaction at the fuel cell stack 101 affects the performance of the fuel cell system 100. Fuel cell performance improves as the pressure of the reactant gases increases. The air compressor 115 is used to push air into the fuel cell stack 101 such that the air is provided to the fuel cell stack 101 at a desired flow rate. As an example, the air compressor 115 may raise the pressure of the incoming air of the fuel cell stack 101 to about 2˜4 times the ambient atmospheric pressure of the fuel cell stack 101.

The fuel cell stack 101 is coupled to a DC/DC converter system 120. The DC/DC converter system 120 may comprise a low power DC/DC converter and a high power DC/DC converter. Fuel cells generate electricity in the form of direct current (DC). The electric power generated by the fuel cell stack 101 may be converted to different levels of DC power to match various load requirements by the DC/DC converter system 120, e.g., to low DC power and high DC power by the low power DC/DC converter and the high power DC/DC converter, respectively. The output of the DC/DC converter system 120 may be a current or voltage. As an example, the DC/DC converter system 120 may be configured to convert a DC voltage output by the fuel cell stack 101 to desired voltage(s). The fuel cell system 100 may include various numbers of DC/DC converters depending on the designs and applications of the fuel cell system 100.

The DC/DC converter system 120 may include a communication module, an input voltage measurement module, an input current measurement module, an output voltage measurement module, and/or an output current measurement module. In some embodiments, the DC/DC converter system 120 may control, according to the communication data of the communication module, specific numerical values of the output current and voltage, and output, through the communication module, data such as input voltages, input currents, output voltages, output currents, etc. The state data of the DC/DC converter system 120 may include DC/DC input currents, and/or DC/DC input voltages.

The DC/DC converter system 120 may be connected to the truck power output 122 through the truck contactor 124. The truck contactor 124 may be a normal open type high-current contactor. The fuel cell system 100 supplies the electric energy generated by the fuel cell stack 101 to external devices/apparatus (referred to as external power receivers thereafter) through the truck power output 122.

The DC/DC converter system 120 may also be connected to the energy storage device 128 through the truck contactor 124 and the battery contactor 126. The electric energy generated by the fuel cell stack 101 may be stored in the energy storage device 128, e.g., a battery. The energy stored in the energy storage device 128 may also be supplied to the external power receivers through the battery contactor 126, the truck contactor 124 and the truck power output 122.

The system controller 116 is configured to manage and control operation of the fuel cell system 100. The system controller 116 may include one or more processors 140, such as microprocessors or microcontrollers, which are appropriately configured to carry out fuel cell system operations. The system controller 116 may further include a computer-readable storage device 142 storing computer-readable instructions, which may be executed by the one or more processors 140 of the system controller 116 for carrying out the fuel cell system operations. The computer-readable storage device 142 may include any non-transitory mechanism for storing information in a form readable by a machine (e.g., a computer, a processor). For example, a computer-readable storage device may include read-only memory (ROM), random-access memory (RAM), magnetic disk storage media, optical storage media, flash-memory devices, solid state storage media, and other storage devices and media.

The system controller 116 may be a controller with an integrated design, which may be a scattered fuel cell controller, a whole vehicle controller, or a battery energy management system. The system controller 116 may include an energy management unit, a fuel cell control unit, an energy storage device monitoring unit, a hydrogen safety monitoring unit, a system failure monitoring unit and/or a startup control unit.

As illustrated in FIG. 2, the system controller 116 may be connected to various components of the fuel cell system 100, such as the fuel cell stack 101, the on/off switch 102, the emergency stop 103, the DC/DC converter system 120, the truck power output 122 through the truck contactor 124, the energy storage 128 through the battery contactor 126, the display 130, the purge valve 132, the exhaust fan(s) 136, the sensor(s) 138, and the actuator 144. The fuel cell inlet 118 supplies air to the fuel cell stack 101, ensuring the necessary oxygen is provided for the electrochemical reactions. Hot or warm exhaust air from the stack 101 can be partially diverted through the exhaust air recirculation door 134 back to the fuel cell inlet 118, maintaining the temperature of the fuel cell inlet air at or above a predetermined level.

As an example, when the on/off switch 102 is switched off, the system controller 116 may receive a signal indicating the switching off of the on/off switch 102, and control to stop operations of the fuel cell system 100, e.g., cutting off the fuel supply to the fuel cell stack 101, turning off the exhaust fan(s) 136, and so on. As another example, the system controller 116 may control supplying power to external power receiver(s) and storing energy in the energy storage device 128. As yet another example, the system controller 116 may control to close and open the purge value 132 to discharge purge exhaust.

The system controller 116 may be connected to the display 130, through which users/operators may interact with the fuel cell system 100. For example, a user may enter instructions through the display 130 and/or set parameter(s) for operations of the fuel cell system 100. A user may monitor operation status or parameters/information displayed on the display 130. The display 130 may be integrated with the system controller 116.

The system controller 116 may be connected to one or more sensors 138. The sensor(s) 138 may include various devices for detecting/sensing/measuring parameters of the fuel cell system 100, such as temperature sensor(s), timer(s), gas density sensor(s)/meter(s), moisture meter(s), and so on. The sensor(s) 138 may be positioned at various locations depending on their purposes.

According to the embodiments of the present application, the sensor(s) 138 may include one or more of the following: an inlet air temperature sensor, which measures the temperature of air entering the fuel cell stack; an exhaust air temperature sensor, which monitors the temperature of air exiting the fuel cell stack to assess heat dissipation; an ambient air temperature sensor, which detects the surrounding environmental temperature of the fuel cell system 100; and a fuel cell temperature sensor, which measures the internal temperature of the fuel cell stack. These sensors may be used in combination or for multiple purposes, providing comprehensive data for advanced thermal management. They are strategically positioned based on their specific functions and provide critical inputs to the system controller, enabling precise control and real-time adjustments for optimal system performance.

The fuel cell power supply system 100 may include at least one exhaust fan 136. Conventionally, each air-cooled fuel cell system can include a plurality of exhaust fans (e.g., two fans for the purpose of expelling hot air and byproducts from the system). The exhaust fan(s) 136 are configured to manage the temperature of the fuel cell power supply system 100 by dissipating heat generated during the electrochemical reactions that occur within the fuel cell stack 101. During the electrochemical process within the fuel cell stack 101, heat is generated as a byproduct. Excessive heat can negatively impact the performance and lifespan of the fuel cell components. The exhaust fan(s) 136 help to regulate the temperature of the fuel cell system 100. Effective thermal management is crucial for maintaining the optimal operating temperature of the fuel cell system 100. Operating at the correct temperature ensures the efficiency and longevity of the fuel cell components.

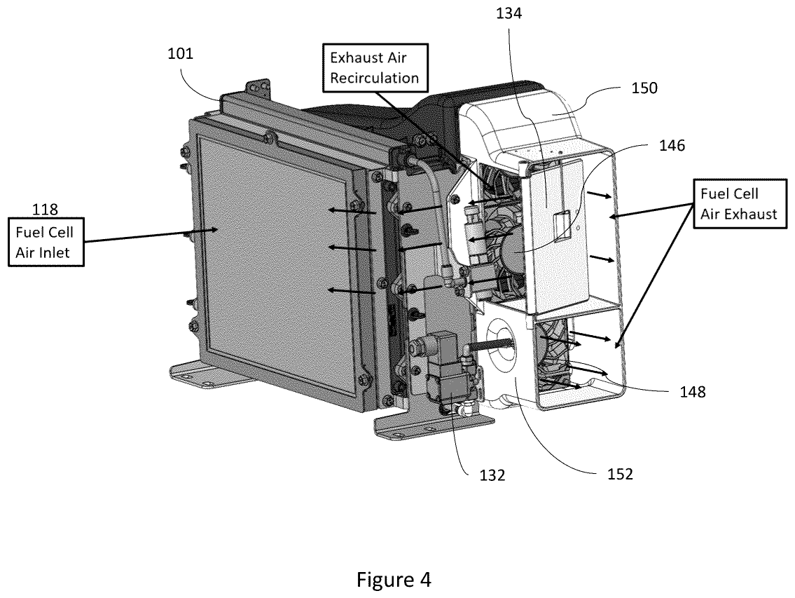

In the present disclosure, the fuel cell system 100 may comprise at least one air shroud positioned around an exhaust fan. The exhaust fan may be positioned at the center of the air shroud. As illustrated in FIGS. 3-5, the fuel cell system 100 may also comprise a plurality of air shrouds. At least one of these air shrouds features a hinged door, referred to interchangeably as the exhaust air recirculation door 134 in the present application (e.g., the hinged door shown in FIGS. 1B, 3, and 4). The air shroud with the exhaust air recirculation door 134 allows the exhaust air to be diverted for recirculation back to the fuel cell inlet 118. This design allows the hot or warm air from the exhaust air to be utilized in maintaining the fuel cell stack's temperature during operation in industrial freezer environments. Specifically, when a detected temperature drops below a predetermined threshold, the hinged door 134 would be actuated to partially divert the hot/warm exhaust air from the fuel cell stack 101 to the fuel cell inlet 118 such that the temperature of the fuel cell inlet air is greater than or equal to the predetermined threshold. In non-freezer environments, the air shroud with the hinged door 134 also allows the fuel cell stack 101 to operate normally by keeping the hinged door 134 closed, allowing all exhaust air to be released out of the system.

FIGS. 3 and 4 provide perspective views of an example fuel cell power supply system in accordance with various embodiments of the present disclosure. This example system includes at least two air exhaust fans, with one of the air shrouds featuring a hinged door 134. In FIG. 3, the hinged door 134 is illustrated in a closed position. In FIG. 4, the hinged door is illustrated as being open at an angle.

As shown in FIG. 3, the system may comprise an upper air exhaust fan 146 and a lower air exhaust fan 148. The upper air exhaust fan 146 is positioned above the lower air exhaust fan 148. The system also includes two air shrouds: an upper air shroud 150 and a lower air shroud 152. The upper air shroud 150 is located above the lower air shroud 152. The upper air shroud 150 is placed outside of the upper air exhaust fan 146. The upper air exhaust fan 146 may be centered within the upper air shroud 150. The upper air shroud 150 includes a hinged door 134. The lower air shroud 152 is placed outside of the lower air exhaust fan 148. The lower air exhaust fan 148 may be centered within the lower air shroud 152.

As shown in FIGS. 3-4, the upper air shroud 150 includes an upper portion, a lower portion, a first sidewall between the upper portion and the lower portion, and a second sidewall between the upper portion and the lower portion. As shown in FIG. 4, the first sidewall of the upper air shroud 150 may function as the hinged door 134. In operation, the first sidewall of the upper air shroud 150 is movable, allowing adjustment of the hinged door 134's opening angle to facilitate air recirculation or exhaust as required.

As shown in FIGS. 3-4, the first sidewall of the upper air shroud 150 may be rectangular in shape with a first long side and a second long side. The first long side of the first sidewall is adjacent to the upper air exhaust fan 146. The hinged door 134 forms at least a portion of the first sidewall 150. In some embodiments, the first sidewall of the upper air shroud 150 functions as the hinged door 134. The first long side of the first sidewall is a movable side of the hinged door 134. The second long side of the first sidewall is a fixed side of the hinged door

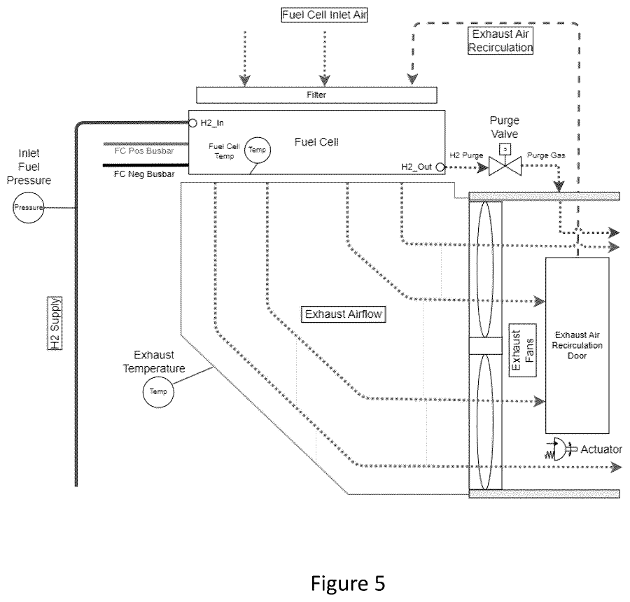

In the present disclosure, the upper air shroud 150 allows the exhaust air to be diverted for recirculation back to the fuel cell inlet 118. The hot/warm exhaust air from the exhaust stream is used to keep the fuel cell stack 101 warm during operation in industrial freezer environments. This shroud design also allows the fuel cell stack 101 to perform normally when not being operated in the freezer environment. In other words, the hinged door 134 remains closed when not being operated in the freezer environment. During normal operation (e.g., the ambient temperature is above 0° C.), the hinged door 134 remains closed, allowing the fuel cell to operate without recirculating exhaust air. All exhaust air flows out of the system through the exhaust fans. However, when specific criteria are met—such as when an exhaust air temperature sensor inside the unit detects that the exhaust air temperature has dropped below 0° C.—the system controller sends a signal to the actuator 144 (shown in FIG. 5) that opens the hinged door 134 to allow the exhaust air to partially redirected back to the fuel cell inlet 118 of the fuel cell stack 101. The opening angle of the hinged door 134 is dynamically adjusted based on the these inputs to maintain inlet air temperature of the fuel cell stack above a predetermined level. Any remaining exhaust air that is not redirected back to the fuel cell inlet 118 of the fuel cell stack 101 is able to be exhausted out of the unit.

FIG. 5 illustrates a simplified diagram of an example fuel cell system, featuring two air exhaust fans and a hinged door 134 in accordance with various embodiments of the present disclosure. The fuel cell system shown in FIG. 5 is an air-cooled fuel cell system. The fuel cell system comprises a fuel cell stack, a system controller, an actuator, an exhaust air temperature sensor, an inlet air temperature sensor, an upper air exhaust fan, a lower air exhaust fan, an upper air shroud placed outside of the upper air exhaust fan, and a lower air shroud placed outside of the lower air exhaust fan. The fuel cell system may also include a fuel cell temperature sensor configured to measure the internal temperature of the fuel cell stack.

The fuel cell receives hydrogen gas via a hydrogen input (H2_In). As shown in FIG. 5, hydrogen is supplied through a dedicated H2 Supply pipeline, with an inlet fuel pressure senor coupled to the pipeline to monitor inlet fuel pressure. The fuel cell is configured to receive fuel cell inlet air through a filter, ensuring proper air quality for the electrochemical reactions. The upper air shroud and the lower air shroud are placed adjacent to the fuel cell. The upper air exhaust fan may be centered within the upper air shroud, and the lower air exhaust fan may be centered within the lower air shroud. In some embodiments, the air shroud may house multiple exhaust fans, which collectively function to dissipate excess heat from the fuel cell and direct exhaust airflow. More particularly, the plurality of exhaust fans are configured to regulate the temperature of the fuel cell system by dissipating excess heat generated during electrochemical reactions that occur within the fuel cell. The FC Pos Busbar and FC Neg Busbar are connected to the fuel cell, enabling efficient power transmission. The FC Pos Busbar collects electrical current from the positive terminal of the fuel cell, while the FC Neg Busbar provides a return path by connecting to the negative terminal. Together, these busbars ensure stable and reliable power flow between the fuel cell and external systems.

In operation, hydrogen (H₂) reacts with oxygen (O₂) within the fuel cell, facilitated by an electrolyte, to generate electricity, water, and heat. However, not all of the supplied hydrogen is consumed in this process. The unused hydrogen (referred to as H2 Purge) exits the fuel cell through the H₂ Out port, which may also carry small amounts of water vapor produced during the electrochemical reaction. This hydrogen and water vapor mixture, known as purge gas or purge exhaust, is directed to a purge valve, which periodically releases accumulated water vapor and impurities from the fuel cell. In some embodiments, the purge exhaust is managed alongside the exhaust air. As shown in FIG. 5, an upper air exhaust fan may be configured to dissipate excess heat generated during electrochemical reactions, expelling hot or warm exhaust air. The purge exhaust may exit the fuel cell system through either the upper air exhaust fan or the lower air exhaust fan, depending on the system configuration and operational requirements.

The upper air shroud may include a hinged door 134, which functions as an exhaust air recirculation door, as shown in FIGS. 3-4. Its opening angle determines how much exhaust air is recirculated back to the fuel cell inlet. Tn actuator is coupled to the hinged door 134. During operation, the opening angle of the hinged door 134 is configured to divert exhaust air from the upper air exhaust fan back to the fuel cell inlet. This recirculation ensures that the temperature of the fuel cell inlet air remains above a predetermined level, thereby optimizing the performance and efficiency of the fuel cell system under varying environmental conditions.

The inlet air temperature sensor is configured to monitor the inlet air temperature of the fuel cell stack. The inlet air temperature sensor may be installed either at the fuel cell inlet 118 or in a location adjacent to it. The inlet air temperature can be measured directly at the point where the air enters the fuel cell stack, at a position within the fuel cell system (e.g., inside the system housing), or determined as an average based on readings from multiple sensors positioned at different points within the system. The exhaust air temperature sensor is configured to monitor the temperature of the exhaust air released from the fuel cell stack. In some embodiments, the exhaust air temperature sensor may be coupled to the air shroud to detect the exhaust air temperature. In some embodiments, the system controller 116 is configured to receive the inlet air temperature measured by the inlet air temperature sensor and the exhaust air temperature measured by the exhaust air temperature sensor. Based on a difference between the exhaust air temperature and the inlet air temperature, the system controller 116 determines the optimal opening angle of the hinged door 134 and controls the actuator 144 to adjust the angle accordingly. The system controller 116 is able to dynamically adjust the opening angle of the hinged door 134 via the actuator 144 to tightly regulate the inlet air temperature and control the recirculation of exhaust air. This precise control ensures the temperature of the fuel cell inlet air consistently remains above the predetermined level, optimizing fuel cell performance.

In some embodiments, the system controller 116 may rely solely on the inlet air temperature measured by the inlet air temperature sensor. The system controller 116 compares the real-time inlet air temperature with a pre-determined threshold (e.g. T1). If the measured inlet air temperature falls below the pre-determined threshold T1, the system controller 116 increases the opening angle of the hinged door 134 by moving it to a wider open position to recirculate warm exhaust air, raising the inlet air temperature. Conversely, if the measured inlet air temperature exceeds the pre-determined threshold T1, the system controller 116 reduces the opening angle of the hinged door 134 by moving it to a more closed position to limit recirculation, allowing cooler ambient air to enter and lower the inlet air temperature.

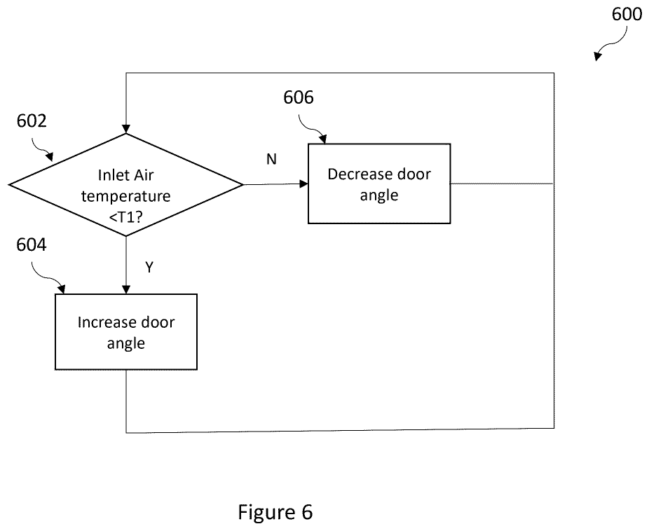

FIG. 6 is a flowchart of an example method 600 for controlling the hinged door 134 shown in FIGS. 1-5 in accordance with various embodiments of the present disclosure. The method 600 provides example operations performed at a fuel cell system (e.g., by use of a system controller), for example, at the fuel cell system 100 by use of the system controller 116 as described with respect to FIGS. 1-5. The fuel cell system monitors an inlet air temperature (e.g., using an inlet air temperature sensor) and determines whether the inlet air temperature is below a predefined threshold, T1 (step 602). If the inlet air temperature falls below the threshold T1, the system controller incrementally increases the hinged door angle to enable recirculation of exhaust air (step 604), thereby raising the inlet air temperature. Conversely, if the inlet air temperature is not below T1, the system controller incrementally decreases the hinged door angle to reduce exhaust air recirculation (step 606). The system controller may perform these adjustments in a loop at predefined time intervals, allowing the system to stabilize the inlet air temperature near the desired threshold while avoiding rapid or excessive adjustments.

In some embodiments, the fuel cell system may monitor the inlet air temperature using an inlet air temperature sensor and compare it against two predefined thresholds: a lower threshold, T1, and an upper threshold, T2, where T2>T1. If the inlet air temperature is below T1, the controller incrementally increases the door angle to allow more airflow and raise the inlet air temperature. Conversely, if the inlet air temperature exceeds T2, the controller incrementally decreases the door angle to reduce airflow and lower the inlet air temperature. If the temperature falls within the range of T1 to T2, no adjustment is made, and the system maintains the current door angle. After each adjustment, the controller may wait for the next time interval before reassessing the temperature, allowing the system to stabilize and preventing rapid, unnecessary adjustments that could lead to inefficiency or instability.

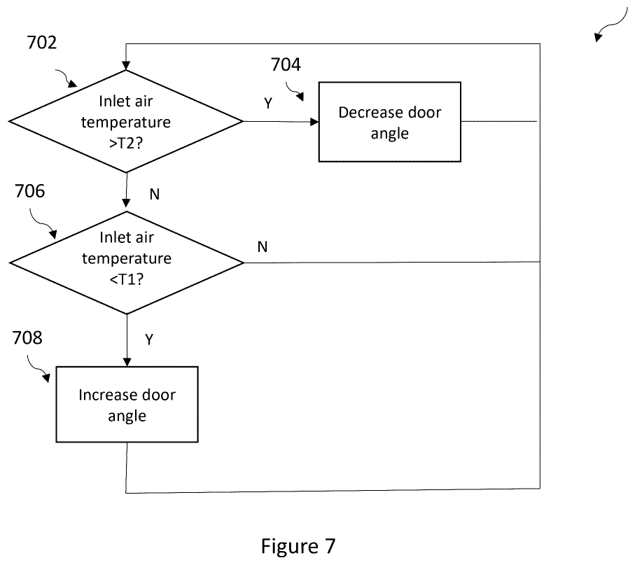

FIG. 7 is a flowchart of an example method 700 of controlling the hinged door 134 shown in FIGS. 1-5 in accordance with various embodiments of the present disclosure. The method 700 provides example operations performed at a fuel cell system (e.g., by use of a system controller), for example, at the fuel cell system 100 by use of the system controller 116 as described with respect to FIGS. 1-5.

The fuel cell system begins by monitoring an inlet air temperature (e.g., using an inlet air temperature sensor) and comparing it against an upper threshold T2 (step 702). If the inlet air temperature exceeds T2, the door angle is decreased to reduce recirculation and allow cooler ambient air to enter (step 704). If the temperature is below T2, the system controller further checks if it is below a lower threshold T1 (step 706). If the inlet air temperature is below the lower threshold T1, the system controller increases the hinged door angle to allow more warm exhaust air to recirculate and raise the inlet air temperature (step 708). If the inlet air temperature is within the range between T1 and T2, no adjustment is made to the hinged door angle. This process is repeated continuously, enabling the system to dynamically adjust the hinged door angle and maintain the inlet air temperature within the desired range (T1 to T2).

According to embodiments of the present disclosure, the fuel cell system may monitor the inlet air temperature (e.g., using an inlet air temperature sensor) and the exhaust air temperature (e.g., using an exhaust air temperature sensor), and determine whether the difference between the exhaust air temperature and the inlet air temperature exceeds a predefined threshold, T1. For example, if the temperature difference exceeds the threshold T1, the system controller incrementally increases the hinged door angle to enable recirculation of exhaust air, thereby raising the inlet air temperature. Conversely, if the temperature difference falls below T1, the system controller incrementally decreases the hinged door angle to reduce exhaust air recirculation. The system controller performs these adjustments in a loop at predefined time intervals, allowing the system to stabilize the inlet air temperature near the desired threshold while avoiding rapid or excessive adjustments.

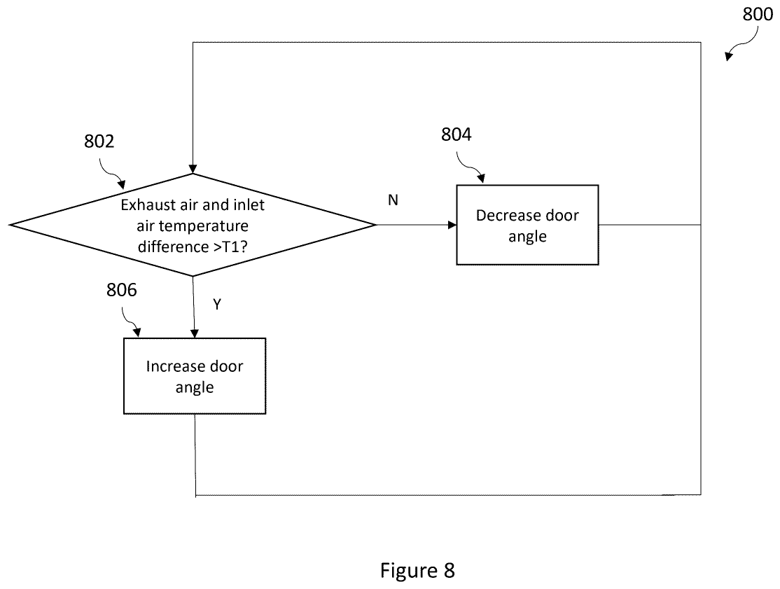

FIG. 8 is a flowchart of an example method 800 of controlling the hinged door 134 shown in FIGS. 1-5 in accordance with various embodiments of the present disclosure. The method 800 provides example operations performed at a fuel cell system (e.g., by use of a system controller), for example, at the fuel cell system 100 by use of the system controller 116 as described with respect to FIGS. 1-5.

The fuel cell system monitors an inlet air temperature (e.g., using an inlet air temperature sensor) and an exhaust air temperature (e.g., using an exhaust air temperature sensor) to calculate the temperature difference. This temperature difference is then compared to a predefined threshold T1 (step 802). If the temperature difference exceeds T1, the system controller increases the hinged door angle (step 806) to allow more warm exhaust air to recirculate, raising the inlet air temperature. If the temperature difference is below T1, the system controller decreases the door angle (step 804) to reduce recirculation and allow more ambient air to enter the system.

In some embodiments, the fuel cell system calculates the temperature difference between the inlet air and exhaust air, and compare it to two predefined thresholds: a lower threshold, T1, and an upper threshold, T2, where T2>T1. If the temperature difference is below T1, the system controller incrementally decreases the door angle to reduce recirculation and allow more ambient air to enter the system. Conversely, if the temperature difference exceeds T2, the system controller incrementally increases the door angle to allow more warm exhaust air to recirculate and raise the inlet air temperature. If the temperature difference falls within the range of T1 to T2, no adjustment is made, and the system controller maintains the current door angle. After each adjustment, the system controller may pause for a specified time interval before reassessing the temperature difference, ensuring system stability and preventing rapid, unnecessary adjustments that could reduce efficiency or cause instability.

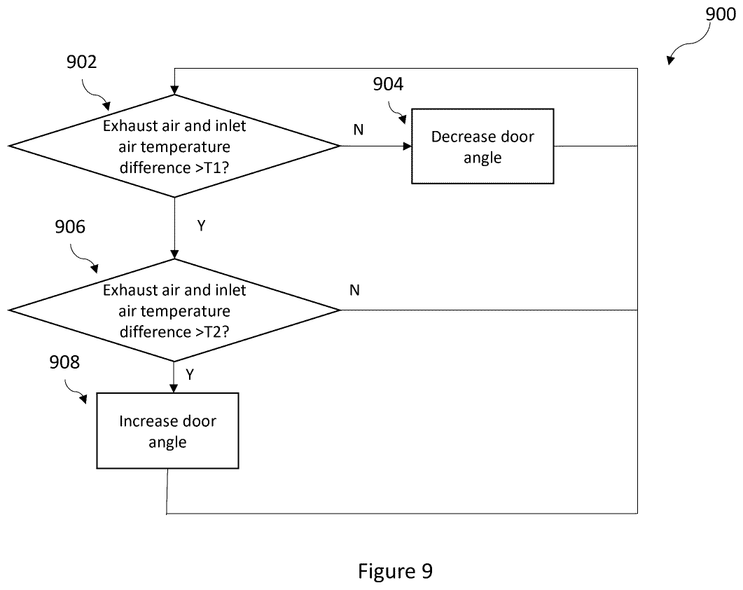

FIG. 9 is a flowchart of an example method 900 of controlling the hinged door shown in FIGS. 1-5 in accordance with various embodiments of the present disclosure. The method 900 provides example operations performed at a fuel cell system (e.g., by use of a system controller), for example, at the fuel cell system 100 by use of the system controller 116 as described with respect to FIGS. 1-5.

The fuel cell system monitors an inlet air temperature (e.g., using an inlet air temperature sensor) and an exhaust air temperature (e.g., using an exhaust air temperature sensor) to calculate the temperature difference. This temperature difference is then compared to a lower threshold T1 (step 902). If the temperature difference does not exceed T1, the system controller decreases the hinged door angle (step 904) to reduce recirculation and allow more ambient air to enter the system. If the temperature difference is above T1, it is further compared the temperature difference to an upper threshold T2 (step 906). If the temperature difference is above T2, the system controller increases the door angle (step 908) to allow more warm exhaust air to recirculate, raising the inlet air temperature. If the temperature difference falls within the range of T1 to T2, no adjustment is made, and the system controller maintains the current door angle.

According to embodiments of the present disclosure, the fuel cell system may further comprise an ambient air temperature sensor, which measures the temperature of the surrounding external environment. The ambient temperature may be a temperature measured at a position outside the fuel cell system (e.g., outside the housing of the fuel cell system), or an average temperature of temperatures measured at multiple positions outside the fuel cell system. In operation, the system controller may be configured to receive the inlet air temperature measured by the inlet air temperature sensor, the exhaust air temperature measured by the exhaust air temperature sensor, and the ambient air temperature measured by the ambient air temperature sensor. Based on the collected temperature data, the system controller determines the optimal opening angle of the hinged door and controls the actuator to adjust the angle. This dynamic adjustment ensures precise regulation of the inlet air temperature, accounting for internal and external thermal conditions to optimize system performance.

The fuel cell system may further comprise a heater placed adjacent to the fuel cell to maintain the temperature of the fuel cell inlet air above a predetermined temperature level. The heater is configured to provide supplemental heat to the inlet air when ambient temperatures fall below an operational threshold. In some embodiments, the heater may be located along the exhaust air pathway, positioned after the recirculation door, to utilize and enhance the heated exhaust air before it is redirected to the inlet. In some other embodiments, the heater may be integrated near the inlet air pathway to directly warm the incoming air.

In some embodiments, the system controller is configured to activate the heater when certain conditions are met. These conditions may include the measured exhaust air temperature, ambient air temperature, or the inlet air temperature drops below a specific threshold. Other possible conditions could include the detection of high humidity levels that could lead to condensation within the fuel cell system, or a rapid decrease in temperature due to external environmental changes. The system controller is able to coordinate the opening angle of the hinged door with the operation of the heater such that the temperature of fuel cell inlet air is tightly regulated.

In some embodiments, the system controller may monitor the opening angle of the hinged door. If the controller detects that the maximum angle (e.g., 90 degrees) has been reached, but a measured temperature remains below a predefined threshold or outside an acceptable range, the system controller can activate the heater. Once the measured temperature rises above the predefined threshold or reenters the acceptable range, the system controller can deactivate the heater.

In some embodiments, the heater may be configured to function independently, utilizing a built-in thermostat or temperature sensor. In this setup, the heater would activate automatically when the ambient air temperature drops below a predefined threshold, operating without direct control from the system controller.

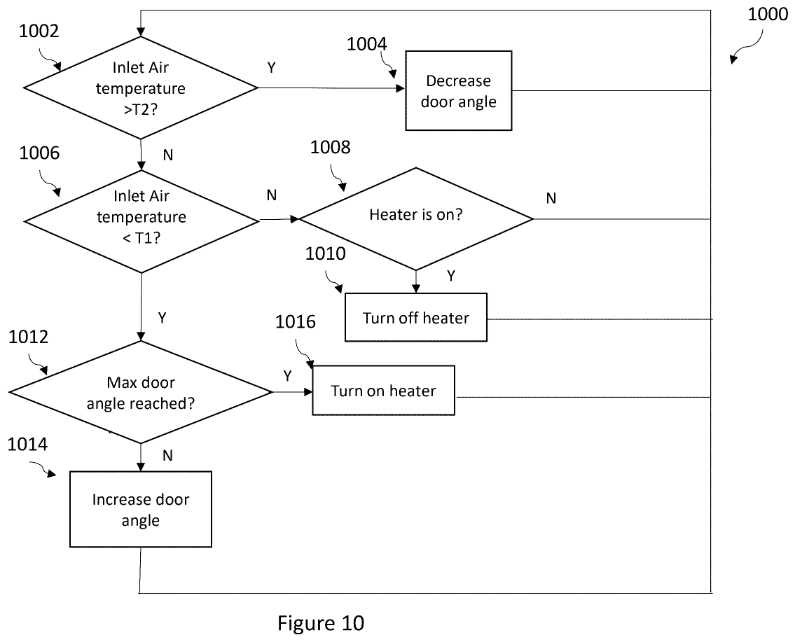

FIG. 10 is a flowchart of an example method 1000 of controlling the hinged door shown in FIGS. 1-5 and a heater in accordance with various embodiments of the present disclosure. The method 1000 provides example operations performed at a fuel cell system (e.g., by use of a system controller), for example, at the fuel cell system 100 by use of the system controller 116 as described with respect to FIGS. 1-5.

As illustrated in FIG. 10, the fuel cell system monitors an inlet air temperature (e.g., using an inlet air temperature sensor) and compares it against two predefined thresholds: a lower threshold, T1, and an upper threshold, T2, where T2>T1. The fuel cell system begins by monitoring an inlet air temperature (e.g., using an inlet air temperature sensor) and comparing it against the upper threshold T2 (step 1002). If the inlet air temperature exceeds the upper threshold, T2, the hinged door angle is incrementally decreased to reduce exhaust air recirculation (step 1004). Conversely, if the inlet air temperature does not exceed T2, the system controller evaluates whether the inlet air temperature has fallen below the lower threshold, T1 (step 1006). If the inlet air temperature is not lower than T1, which means the inlet air temperature remains within the range of T1 to T2, the system controller checks whether the heater is active (step 1008). If the heater is active, it is turned off (step 1010). Otherwise, no adjustment is made to the hinged door angle or the heater. If the inlet air temperature is below T1, the system controller determines whether the hinged door angle has reached its maximum opening (step 1012). If the maximum angle has not been reached, the hinged door angle is incrementally increased to allow more exhaust air recirculation and raise the inlet air temperature (step 1014). However, if the door angle has already reached its maximum, the heater is activated to further increase the inlet air temperature (step 1016). This control logic operates in a continuous loop, enabling precise regulation of the inlet air temperature while maintaining system stability and operational efficiency.

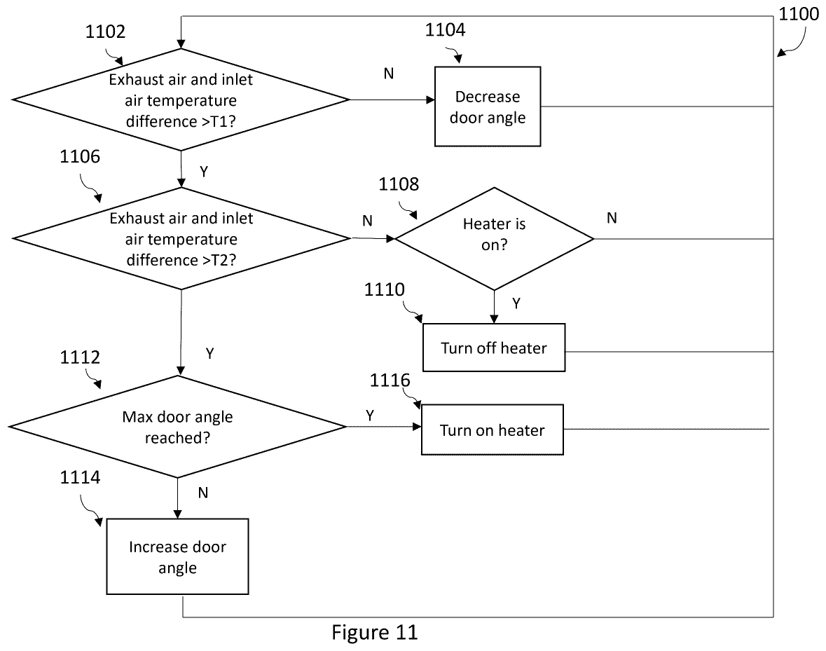

FIG. 11 is a flowchart of an example method 1100 of controlling the hinged door shown in FIGS. 1-5 and a heater in accordance with various embodiments of the present disclosure. The method 1100 provides example operations performed at a fuel cell system (e.g., by use of a system controller), for example, at the fuel cell system 100 by use of the system controller 116 as described with respect to FIGS. 1-5.

As shown in FIG. 11, the fuel cell system monitors the temperature difference between the exhaust air and the inlet air. This difference is compared against two predefined thresholds: a lower threshold, T1, and an upper threshold, T2, where T2>T1. T2 represents a larger temperature differential. The system controller evaluates whether the temperature difference is above the lower threshold T1 (step 1102). If the temperature difference does not exceed the lower threshold T1, the hinged door angle is incrementally decreased to reduce exhaust air recirculation (step 1104). If the temperature difference exceeds T1, the system controller evaluates whether the temperature difference is above the upper threshold, T2 (step 1106). If the temperature difference does not exceed T2, which means the temperature difference remains within the range of T1 to T2, the system controller checks whether the heater is active (step 1108). If the heater is active, it is turned off (step 1110). Otherwise, no adjustments are made to the hinged door angle or the heater. If the temperature difference is greater than T2, the system controller determines whether the hinged door angle has reached its maximum opening (step 1112). If the maximum angle has not been reached, the hinged door angle is incrementally increased to allow more exhaust air recirculation and raise the temperature difference (step 1114). However, if the door angle has already reached its maximum, the heater is activated to further increase the inlet air temperature (step 1116). This control logic operates in a continuous loop, enabling precise regulation of the temperature difference while maintaining system stability and operational efficiency. After each adjustment, the system controller may pause for a specified time interval before reassessing the temperature difference, ensuring system stability and preventing rapid, unnecessary adjustments that could reduce efficiency or cause instability.

In some embodiments, the heater may also be incorporated into the control logic depicted in FIGS. 6-9. Specifically, the heater can be activated when the system controller determines that additional heating is required. For example, if the temperature (or temperature difference) remains below the threshold T1 and the maximum door angle has already been reached, the heater may be activated to raise the inlet air temperature or reduce the temperature difference. Conversely, the heater may be deactivated when the temperature is above T1, ensuring efficient thermal management and preventing unnecessary energy consumption.

In some embodiments, the heater may be activated when the door angle approaches the maximum opening angle (e.g., 80 degrees), allowing the heater to activate preemptively. Additionally, the heater may be triggered under other criteria, such as when the ambient air temperature falls below a predetermined threshold. Conversely, the heater may be deactivated under different conditions, such as when the door angle is nearly closed (e.g., close to zero degrees) or reaches a specific degree, or when the ambient air temperature or the inlet air temperature rises above a predetermined threshold.

In some embodiments, the fuel cell system may also monitor its ambient temperature for cooling control. The control logic illustrated in FIGS. 6-11 may be adapted to utilize the temperature difference between the ambient air and the inlet air, or a combination of all three temperatures—ambient, inlet, and exhaust air—for more precise regulation. For instance, if the temperature difference between the ambient air and the inlet air exceeds a predefined threshold, the system may reduce the hinged door angle to limit exhaust air recirculation, allowing cooler ambient air to flow in and lower the inlet air temperature. Otherwise, the system may increase the hinged door angle or activate the heater to maintain optimal inlet air temperature conditions.

Furthermore, when considering all three temperature parameters, the system controller can dynamically calculate thresholds based on the combined influence of ambient, inlet, and exhaust air temperatures. For example, the controller may calculate a weighted difference between exhaust and inlet air temperatures relative to the ambient air temperature to determine whether adjustments to the hinged door angle or heater activation are required. This multi-parameter approach ensures that the system responds appropriately to complex environmental and operational conditions, optimizing both cooling and heating functions.

In some embodiments, the system controller may control the hinged door at fixed time intervals (e.g., every 5 seconds, 10 seconds, etc.). During each interval, the controller evaluates the current conditions, including temperature measurements, and determines whether to adjust the hinged door angle or activate or deactivate the heater, ensuring precise and efficient system operation.

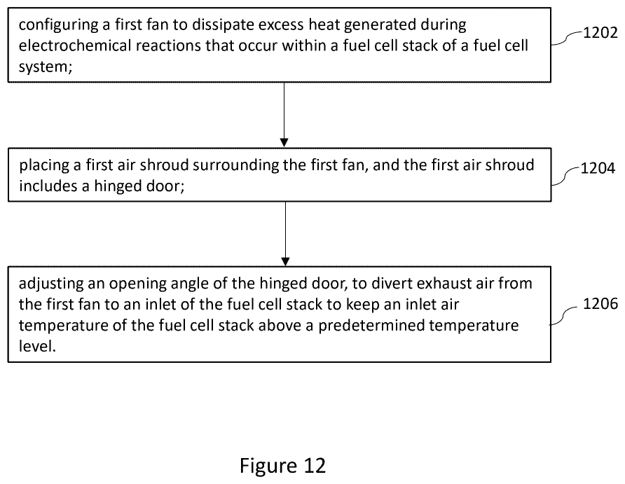

FIG. 12 illustrates a flow chart of a method for controlling the hinged door shown in FIGS. 1-5 in accordance with various embodiments of the present disclosure. This flowchart shown in FIG. 12 is merely an example, which should not unduly limit the scope of the claims. One of ordinary skill in the art would recognize many variations, alternatives, and modifications. For example, various steps illustrated in FIG. 12 may be added, removed, replaced, rearranged and repeated.

At step 1202, a first fan is configured to dissipate excess heat generated during electrochemical reactions that occur within a fuel cell stack of a fuel cell system.

At step 1204, a first air shroud is placed surrounding the first fan, and the first air shroud includes a hinged door.

At step 1206, an opening angle of the hinged door is adjusted to divert exhaust air from the first fan to an inlet of the fuel cell stack to keep an inlet air temperature of the fuel cell stack above a predetermined temperature level.

The method further comprises detecting the inlet air temperature of the fuel cell stack and determining the opening angle of the hinged door based on the inlet air temperature of the fuel cell stack.

The method further comprises comparing the inlet air temperature of the fuel cell stack to a first threshold and a second threshold, wherein the second threshold is higher than the first threshold, decreasing the opening angle of the hinged door by moving it toward a more closed position when the inlet air temperature of the fuel cell stack is above the second threshold, increasing the opening angle of the hinged door by moving it to a wider open position when the inlet air temperature of the fuel cell stack is below the first threshold, and maintaining a current opening angle of the hinged door when the inlet air temperature of the fuel cell stack is between the first threshold and the second threshold.

The method further comprises detecting the inlet air temperature of the fuel cell stack, detecting an exhaust air temperature of the fuel cell stack, and determining the opening angle of the hinged door based on a temperature difference between the exhaust air temperature of the fuel cell stack and the inlet air temperature of the fuel cell stack.

The method further comprises comparing the temperature difference between the exhaust air temperature of the fuel cell stack and the inlet air temperature of the fuel cell stack to a first threshold and a second threshold, wherein the second threshold is higher than the first threshold, increasing the opening angle of the hinged door by moving it to a wider open position when the temperature difference between the exhaust air temperature and the inlet air temperature exceeds the second temperature threshold, decreasing the opening angle of the hinged door by moving it toward a more closed position when the temperature difference between the exhaust air temperature and the inlet air temperature falls below the first temperature threshold, and maintaining a current opening angle of the hinged door when the temperature difference between the exhaust air temperature and the inlet air temperature is within a range of the first temperature threshold and the second temperature threshold.

The method further comprises detecting the opening angle of the hinged door, activating a heater when the temperature difference between the exhaust air temperature and the inlet air temperature is above the second threshold and the opening angle of the hinged door reaches a maximum angle, and deactivating the heater when the temperature difference between the exhaust air temperature and the inlet air temperature is between the first threshold and the second threshold.

The method further comprises configuring a second fan to dissipate the excess heat and purge gas generated during the electrochemical reactions, placing a second air shroud surrounding the second fan, and positioning the first fan and the first air shroud above the second fan and the second air shroud, wherein the first fan and the second fan are centered within their respective air shrouds.

The method further comprises configuring an actuator to adjust the opening angle of the hinged door, configuring a system controller to control the actuator to dynamically adjust the opening angle of the hinged door, and activating a heater positioned adjacent to the fuel cell stack when the opening angle of the hinged door reaches a maximum angle and the inlet air temperature of the fuel cell stack is below the predetermined temperature level.

The method further comprises detecting an internal temperature of the fuel cell stack, detecting an exhaust air temperature of the fuel cell stack, detecting an ambient air temperature of the fuel cell system, and determining the opening angle of the hinged door based on the exhaust air temperature of the fuel cell stack, the internal temperature of the fuel cell stack, and the ambient air temperature of the fuel cell system.

In some embodiments, the fuel cell temperature sensor, which measures the internal temperature of the fuel cell stack, may be used as an alternative to the inlet air temperature sensor in the control logics depicted in FIGS. 8-12. For instance, the fuel cell temperature sensor can replace the inlet air temperature sensor in determining whether to adjust the hinged door angle or activate the heater, ensuring that the fuel cell stack operates within its optimal temperature range.

In some other embodiments, the fuel cell temperature sensor may be used in conjunction with one or more other sensors, such as the inlet air temperature sensor, exhaust air temperature sensor, or ambient air sensor, to make more informed decisions. The system may employ different combinations of these sensors, depending on specific requirements or operating conditions, without necessarily using all the sensors at once. By leveraging data from selected sensors, the system can evaluate thermal conditions more effectively, enabling precise adjustments to the hinged door angle, heater activation, fan speed, or a combination thereof. This flexible, multi-sensor approach enhances the system's adaptability and efficiency in maintaining optimal thermal management.

Although an actuator is used in the above embodiments, other mechanisms may be employed to receive signals from the system controller and control the opening angle of the hinged door. For example, a motorized mechanism such as a stepper motor or servo motor can be used to control the opening angle of the hinged door. Alternatively, solenoid-based systems may be utilized for discrete or binary adjustments, while pneumatic or electro-pneumatic systems can regulate the door angle through pressure changes. Electromagnetic clutch systems and shape-memory alloy (SMA)-driven mechanisms are additional options that can translate the system controller's commands into mechanical movements.

Although embodiments of the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A system comprising:
a first fan configured to dissipate excess heat generated during electrochemical reactions that occur within a fuel cell stack of a fuel cell system and to direct exhaust air of the fuel cell system; and
a first air shroud surrounding the first fan, wherein the first air shroud includes a hinged door, and the hinged door is configured to divert exhaust air from the first fan to an inlet of the fuel cell stack to keep an inlet air temperature of the fuel cell stack above a predetermined temperature level.

2. The system of claim 1, further comprising:
a second fan configured to dissipate the excess heat and purge gas generated during the electrochemical reactions; and
a second air shroud surrounding the second fan, wherein the first fan and first air shroud are positioned above the second fan and second air shroud.

3. The system of claim 2, wherein:
the first air shroud further includes an upper portion, a lower portion, a first sidewall between the upper portion and the lower portion, and a second sidewall between the upper portion and the lower portion; and
the hinged door forms at least a portion of the first sidewall or constitutes the entirety of the first sidewall, and the hinged door is movable to provide a controllable opening angle of the hinged door.

4. The system of claim 3, wherein:
the first sidewall is rectangular in shape, with a first long side and a second long side, and the first sidewall constitutes the entirety of the hinged door, wherein:
the first long side of the first sidewall is adjacent to the first fan and is a movable side; and
the second long side is a fixed side.

5. The system of claim 1, further comprising:
an actuator operatively coupled to the hinged door, wherein the actuator dynamically adjusts an opening angle of the hinged door to keep the inlet air temperature of the fuel cell stack above the predetermined temperature level.

6. The system of claim 1, further comprising:
an inlet air temperature sensor configured to measure the inlet air temperature of the fuel cell stack; and
a system controller configured to adjust an opening angle of the hinged door based on the inlet air temperature of the fuel cell stack and the predetermined temperature level.

7. The system of claim 1, further comprising:
an exhaust air temperature sensor configured to measure an exhaust air temperature of the fuel cell stack;
an inlet air temperature sensor configured to measure the inlet air temperature of the fuel cell stack; and
a system controller configured to adjust an opening angle of the hinged door based on a temperature difference between the exhaust air temperature of the fuel cell stack and the inlet air temperature of the fuel cell stack.

8. The system of claim 7, wherein:
the system controller is further configured to adjust the opening angle of the hinged door based on a first temperature threshold and a second temperature threshold, wherein the second temperature threshold is higher than the first temperature threshold;
the system controller is configured to increase the opening angle of the hinged door by moving it to a wider open position when the temperature difference between the exhaust air temperature and the inlet air temperature exceeds the second temperature threshold;
the system controller is configured to decrease the opening angle of the hinged door by moving it toward a more closed position when the temperature difference between the exhaust air temperature and the inlet air temperature falls below the first temperature threshold; and
the system controller is configured to maintain a current opening angle of the hinged door when the temperature difference between the exhaust air temperature and the inlet air temperature is within a range of the first temperature threshold and the second temperature threshold.

9. The system of claim 8, further comprising:
a heater configured to activate when the temperature difference between the exhaust air temperature and the inlet air temperature exceeds the second temperature threshold and the hinged door has reached its maximum opening angle, and to deactivate when the temperature difference between the exhaust air temperature and the inlet air temperature is within the range of the first temperature threshold and the second temperature threshold.

10. The system of claim 1, further comprising:
a heater configured to activate, when the inlet air temperature of the fuel cell stack is below the predetermined temperature level and the hinged door has reached a maximum opening angle.

11. The system of claim 1, further comprising:
an exhaust air temperature sensor configured to measure an exhaust air temperature of the fuel cell stack;
a fuel cell temperature sensor configured to measure an internal temperature of the fuel cell stack;
an ambient air temperature sensor configured to measure an ambient air temperature of the fuel cell system; and
a system controller, wherein the system controller is configured to adjust an opening angle of the hinged door based on the exhaust air temperature of the fuel cell stack, the internal temperature of the fuel cell stack, and the ambient air temperature of the fuel cell system.

12. A method comprising:
configuring a first fan to dissipate excess heat generated during electrochemical reactions that occur within a fuel cell stack of a fuel cell system;
placing a first air shroud surrounding the first fan, wherein the first air shroud includes a hinged door; and
adjusting an opening angle of the hinged door, to divert exhaust air from the first fan to an inlet of the fuel cell stack to keep an inlet air temperature of the fuel cell stack above a predetermined temperature level.

13. The method of claim 12, further comprising:
detecting the inlet air temperature of the fuel cell stack; and
determining the opening angle of the hinged door based on the inlet air temperature of the fuel cell stack.

14. The method of claim 13, further comprising:
comparing the inlet air temperature of the fuel cell stack to a first threshold and a second threshold, wherein the second threshold is higher than the first threshold;
decreasing the opening angle of the hinged door by moving it toward a more closed position when the inlet air temperature of the fuel cell stack is above the second threshold;
increasing the opening angle of the hinged door by moving it to a wider open position when the inlet air temperature of the fuel cell stack is below the first threshold; and
maintaining a current opening angle of the hinged door when the inlet air temperature of the fuel cell stack is between the first threshold and the second threshold.

15. The method of claim 12, further comprising:
detecting the inlet air temperature of the fuel cell stack;
detecting an exhaust air temperature of the fuel cell stack; and
determining the opening angle of the hinged door based on a temperature difference between the exhaust air temperature of the fuel cell stack and the inlet air temperature of the fuel cell stack.

16. The method of claim 15, further comprising:
comparing the temperature difference between the exhaust air temperature of the fuel cell stack and the inlet air temperature of the fuel cell stack to a first threshold and a second threshold, wherein the second threshold is higher than the first threshold;
increasing the opening angle of the hinged door by moving it to a wider open position when the temperature difference between the exhaust air temperature and the inlet air temperature exceeds the second temperature threshold;
decreasing the opening angle of the hinged door by moving it toward a more closed position when the temperature difference between the exhaust air temperature and the inlet air temperature falls below the first temperature threshold; and
maintaining a current opening angle of the hinged door when the temperature difference between the exhaust air temperature and the inlet air temperature is within a range of the first temperature threshold and the second temperature threshold.

17. The method of claim 16, further comprising:
detecting the opening angle of the hinged door;
activating a heater when the temperature difference between the exhaust air temperature and the inlet air temperature is above the second threshold and the opening angle of the hinged door reaches a maximum angle; and
deactivating the heater when the temperature difference between the exhaust air temperature and the inlet air temperature is between the first threshold and the second threshold.

18. The method of claim 12, further comprising:
configuring a second fan to dissipate the excess heat and purge gas generated during the electrochemical reactions;
placing a second air shroud surrounding the second fan; and
positioning the first fan and the first air shroud above the second fan and the second air shroud, wherein the first fan and the second fan are centered within their respective air shrouds.

19. The method of claim 18, further comprising:
configuring an actuator to adjust the opening angle of the hinged door;
configuring a system controller to control the actuator to dynamically adjust the opening angle of the hinged door; and
activating a heater positioned adjacent to the fuel cell stack when the opening angle of the hinged door reaches a maximum angle and the inlet air temperature of the fuel cell stack is below the predetermined temperature level.

20. The method of claim 18, further comprising:
detecting an internal temperature of the fuel cell stack;
detecting an exhaust air temperature of the fuel cell stack;
detecting an ambient air temperature of the fuel cell system; and
determining the opening angle of the hinged door based on the exhaust air temperature of the fuel cell stack, the internal temperature of the fuel cell stack, and the ambient air temperature of the fuel cell system.
